(19) United States
(12) Patent Application Publication
(10) Pub. No.: US 2023/0221132 A1
(43) Pub. Date: Jul. 13, 2023

(54) INFORMATION PROCESSING APPARATUS, METHOD, AND NON-TRANSITORY COMPUTER READABLE MEDIUM

(71) Applicant: TOYOTA JIDOSHA KABUSHIKI KAISHA, Toyota-shi (JP)

(72) Inventors: Hiroshi OKI, Seto-shi (JP); Daigo KITTAKA, Yokohama-shi (JP)

(73) Assignee: TOYOTA JIDOSHA KABUSHIKI KAISHA, Toyota-shi (JP)

(21) Appl. No.: 18/151,105

(22) Filed: Jan. 6, 2023

(30) Foreign Application Priority Data
Jan. 11, 2022 (JP) 2022-002634

(51) Int. Cl. G01C 21/34; G01C 21/36; B60L 58/12

(52) U.S. Cl. CPC G01C 21/3469; B60L 58/12; G01C 21/3605

(57) ABSTRACT

A controller of an information processing apparatus determines whether a vehicle having a battery for driving is to enter a target area; acquires or estimates an arrival time of the vehicle at the target area and a departure time of the vehicle from the target area, in a case in which it is determined that the vehicle is to enter the target area; and adds a required charge amount of the battery to a demand for electrical energy during a target time period in the target area, in a case in which a charge time period of the battery in the target area is included in the target time period.

### CROSS-REFERENCE TO RELATED APPLICATION

This application claims priority to Japanese Patent Application No. 2022-002634 filed on Jan. 11, 2022, the entire contents of which are incorporated herein by reference.

### TECHNICAL FIELD

The present disclosure relates to an information processing apparatus, a method, and a program.

### BACKGROUND

Technology for predicting demands for electrical energy is known. For example, Patent Literature (PTL) 1 discloses technology for predicting future charge amounts of Battery Electric Vehicles (BEVs) in certain regions.

### CITATION LIST

### Patent Literature

PTL 1: JP 2016-134160 A

### SUMMARY

There is room for improvement with respect to technology for predicting demands for electrical energy.

It would be helpful to improve technology for predicting demands for electrical energy.

An information processing apparatus according to an embodiment of the present disclosure is an information processing apparatus including a controller configured to:
determine whether a vehicle having a battery for driving is to enter a target area;
acquire or estimate an arrival time of the vehicle at the target area and a departure time of the vehicle from the target area, in a case in which it is determined that the vehicle is to enter the target area; and
add a required charge amount of the battery to a demand for electrical energy during a target time period in the target area, in a case in which a charge time period of the battery in the target area is included in the target time period.

A method according to an embodiment of the present disclosure is a method performed by an information processing apparatus, the method including:
determining whether a vehicle having a battery for driving is to enter a target area;
acquiring or estimating an arrival time of the vehicle at the target area and a departure time of the vehicle from the target area, in a case in which it is determined that the vehicle is to enter the target area; and
adding a required charge amount of the battery to a demand for electrical energy during a target time period in the target area, in a case in which a charge time period of the battery in the target area is included in the target time period.

A program according to an embodiment of the present disclosure is configured to cause a computer to execute operations, the operations including:
determining whether a vehicle having a battery for driving is to enter a target area;
acquiring or estimating an arrival time of the vehicle at the target area and a departure time of the vehicle from the target area, in a case in which it is determined that the vehicle is to enter the target area; and
adding a required charge amount of the battery to a demand for electrical energy during a target time period in the target area, in a case in which a charge time period of the battery in the target area is included in the target time period.

According to an embodiment of the present disclosure, technology for predicting demands for electrical energy can be improved.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a block diagram illustrating a schematic configuration of an information processing apparatus according to the embodiment of the present disclosure; and

FIG. 3 is a flowchart illustrating operations of the information processing apparatus according to the embodiment of the present disclosure.

### DETAILED DESCRIPTION

Hereinafter, an embodiment of the present disclosure will be described.

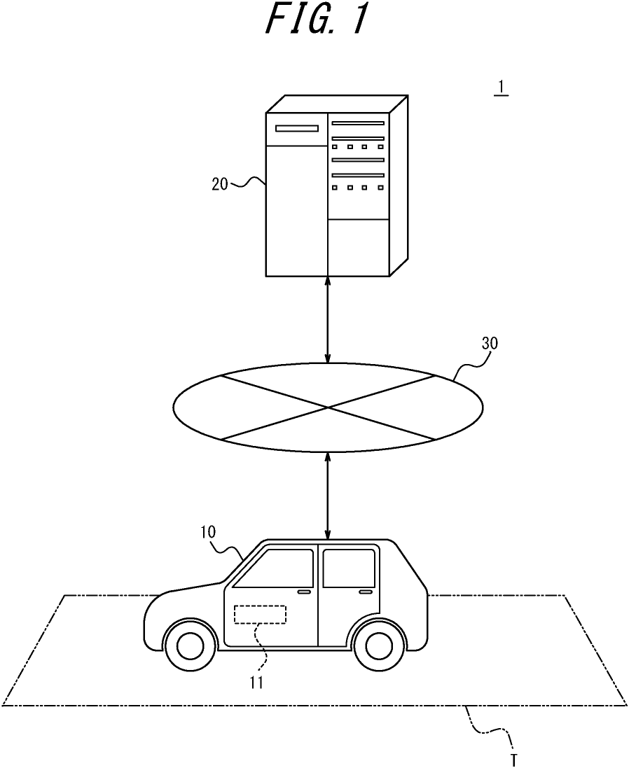

An outline of a system 1 according to an embodiment of the present disclosure will be described with reference to FIG. 1.

The system 1 includes a vehicle 10 and an information processing apparatus 20. The vehicle 10 and the information processing apparatus 20 are communicably connected to a network 30.

The vehicle 10 is any vehicle having a battery 11 for driving. The vehicle 10 is, for example, a Battery Electric Vehicle (BEV), a Hybrid Electric Vehicle (HEV), a Plug-in Hybrid Electric Vehicle (PHEV), a Fuel Cell Electric Vehicle (FCEV), or the like, but is not limited to these. The vehicle 10 may be driven by a driver, or the driving may be automated at any level. The level of automation is, for example, one of level 1 to level 5 according to the classification of the Society of Automotive Engineers (SAE). The vehicle 10 may be a dedicated Mobility as a Service (MaaS) vehicle.

The information processing apparatus 20 is a computer such as a server that belongs to a cloud computing system or another type of computing system.

The network 30 includes the Internet, at least one wide area network (WAN), at least one metropolitan area network (MAN), or any combination thereof. The network 30 may include at least one wireless network, at least one optical network, or any combination thereof. The wireless network is, for example, an ad hoc network, a cellular network, a wireless local area network (LAN), a satellite communication network, or a terrestrial microwave network.

An outline of the present embodiment will be described with reference to FIG. 1.

A controller 21 of the information processing apparatus 20 determines whether the vehicle 10 having the battery 11 for driving is to enter a target area T. Upon determining that the vehicle 10 is to enter the target area T, the controller 21 estimates an arrival time of the vehicle 10 at the target area T and a departure time of the vehicle 10 from the target area T. Then, in a case in which a charge time period of the battery 11 in the target area T is included in a target time period, the controller 21 adds a required charge amount of the battery 11 to a demand for electrical energy during the target time period in the target area T.

In a case in which an excessive demand for electrical energy arises in a city block or the like, after completion of an electrical energy contract, there is a need to purchase additional electrical energy. However, purchasing the electrical energy after the completion of the electrical energy contract becomes relatively expensive. For example, in a case in which demands for charging batteries 11 for driving in vehicles 10 parked in the target area T increase, there may be a need to purchase additional electrical energy after the completion of the electrical energy contract. According to the present embodiment, even in a case in which demands for charging the batteries 11 for driving in the vehicles 10 tend to increase, required charge amounts of the batteries 11 for driving in the vehicles 10 are added in advance to a demand for electrical energy in the target area T. Thus, technology for predicting demands for electrical energy can be improved.

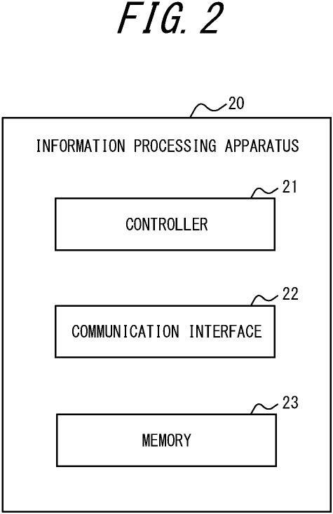

A configuration of the information processing apparatus 20 according to the present embodiment will be described with reference to FIG. 2.

The information processing apparatus 20 includes the controller 21, a communication interface 22, and a memory 23.

The controller 21 includes at least one processor, at least one programmable circuit, at least one dedicated circuit, or any combination thereof. The processor is a general purpose processor such as a central processing unit (CPU) or a graphics processing unit (GPU), or a dedicated processor that is dedicated to specific processing. The programmable circuit is, for example, a field-programmable gate array (FPGA). The dedicated circuit is, for example, an application specific integrated circuit (ASIC). The controller 21 executes processes related to operations of the information processing apparatus 20 while controlling components of the information processing apparatus 20.

The communication interface 22 includes at least one interface for communication. The interface for communication is compliant with, for example, a mobile communication standard, a wired LAN standard, or a wireless LAN standard, but not limited to these, and may be compliant with any communication standard. The communication interface 22 receives data to be used for the operations of the information processing apparatus 20, and transmits data obtained by the operations of the information processing apparatus 20.

The memory 23 includes at least one semiconductor memory, at least one magnetic memory, at least one optical memory, or any combination thereof. The semiconductor memory is, for example, random access memory (RAM) or read only memory (ROM). The RAM is, for example, static random access memory (SRAM) or dynamic random access memory (DRAM). The ROM is, for example, electrically erasable programmable read only memory (EEPROM). The memory 23 functions as, for example, a main memory, an auxiliary memory, or a cache memory. The memory 23 stores data to be used for the operations of the information processing apparatus 20 and data obtained by the operations of the information processing apparatus 20. In the present embodiment, the data to be used for the operations of the information processing apparatus 20 includes a system program, an application program, a database, map information, and the like.

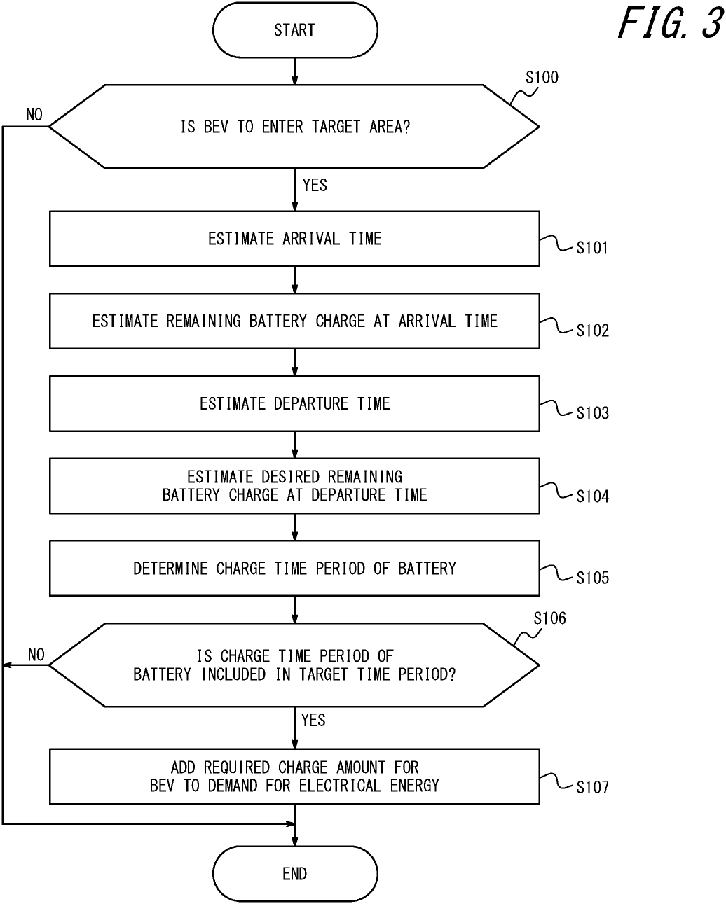

Operations of the information processing apparatus 20 according to the present embodiment will be described with reference to FIG. 3. These operations correspond to a method according to an embodiment of the present disclosure.

In this example, as the vehicle 10 having the battery 11 for driving, a BEV 10 that visits a target area T from outside the target area T and that is parked in a parking lot or the like provided in the target area T from a time of arrival until a time of next departure will be described. In this example, as the target time period, a weekday following a day on which steps S100 through S107 described below are executed will be described. However, the present disclosure is not limited to these. The number of BEVs 10 may be arbitrarily determined. In a case in which there are multiple BEVs 10, the controller 21 of the information processing apparatus 20 performs steps S100 through S107 described below for each of the BEVs 10.

Step S100: The controller 21 of the information processing apparatus 20 determines whether the BEV 10 is to enter the target area T during the target time period. In a case in which it is determined that the BEV 10 is to enter the target area T, the process proceeds to step S101. On the other hand, in a case in which it is not determined that the BEV 10 is to enter the target area T, the process ends.

Specifically, the controller 21 of the information processing apparatus 20 acquires, via the communication interface 22 from the BEV 10, history information including a departure location, departure time, arrival location, arrival time, travel route, remaining battery charge (State Of Charge; SOC) at the departure time, and the like for one trip (for example, around 9:00 am) on which a user commuted in the past by the BEV 10. The controller 21 determines whether the BEV 10 is to enter the target area T on the following weekday, based on the acquired history information. In this example, when it is found out from the history information that the BEV 10 usually visits the target area T at around 9:00 am (for example, 9:00 am ± 5 minutes) on weekdays, the controller 21 determines that the BEV 10 is to visit the target area T at around 9:00 am on the following weekday.

Step S101: The controller 21 of the information processing apparatus 20 estimates an arrival time of the BEV 10 at the target area T.

Specifically, the controller 21 of the information processing apparatus 20 estimates the arrival time of the BEV 10 at the target area T, based on the history information acquired in step S100. In this example, when it is found out from the history information that the arrival time of the BEV 10 at the target area T is usually around 9:00 am, the controller 21 estimates that the arrival time of the BEV 10 at the target area T on the following weekday is also to be around 9:00 am.

Step S102: The controller 21 of the information processing apparatus 20 estimates a remaining battery charge of the battery 11 of the BEV 10 at the arrival time estimated in step S101.

Specifically, the controller 21 of the information processing apparatus 20 estimates the remaining battery charge of the battery 11 of the BEV 10 at the arrival time estimated in step S101, based on the history information acquired in step S100. In this example, when it is found out from the history information that the remaining battery charge of the battery 11 of the BEV 10 at the arrival time is usually of the order of 20% (for example, 20% ± 5%), the controller 21 estimates that the remaining battery charge of the battery 11 of the BEV 10 at the arrival time on the following weekday is also to be of the order of 20%. Alternatively, when it is predicted that a remaining battery charge of the battery 11 of the BEV 10 at a departure time of the following weekday is to be different from the usual remaining battery charge, due to charging during night-time or the like, the controller 21 may estimate the remaining battery charge of the battery 11 of the BEV 10 at the arrival time, based on the estimated remaining battery charge and the travel route on the following weekday, estimated from the history information acquired in step S100.

Step S103: The controller 21 of the information processing apparatus 20 estimates a departure time of the BEV 10 from the target area T.

Specifically, the controller 21 of the information processing apparatus 20 estimates the departure time of the BEV 10 from the target area T, based on the history information acquired in step S100. In this example, when it is found out from the history information that the departure time of the BEV 10 from the target area T is usually around 5:00 pm (for example, 5:00 pm ± 5 minutes), the controller 21 estimates that the departure time of the BEV 10 from the target area T on the following weekday is also to be around 5:00 pm. The BEV 10 is to be parked in the parking lot provided in the target area T from the time of arrival at the target area T until the time of departure from the target area T.

Here, the controller 21 of the information processing apparatus 20 may estimate the departure time based on schedule information on the user of the BEV 10, instead of the history information described above. Specifically, the controller 21 acquires the schedule information on the user of the BEV 10 via the communication interface 22 from an application or the like that enables creation of a schedule using the Internet. The controller 21 specifies, from the acquired schedule information, a travel distance from a current location, i.e. the parking lot in the target area T, to a next scheduled destination. The controller 21 estimates the departure time from the target area T, based on the specified travel distance.

Step S104: The controller 21 of the information processing apparatus 20 estimates a desired remaining battery charge of the battery 11 of the BEV 10 at the departure time estimated in step S103.

Specifically, the controller 21 of the information processing apparatus 20 estimates the desired remaining battery charge of the battery 11 of the BEV 10 at the departure time estimated in step S103, based on the history information acquired in step S100. In this example, when a remaining battery charge of the battery 11 of the BEV 10 at the departure time is usually of the order of 90% (for example, 90% ± 5%), the controller 21 estimates that the remaining battery charge of the battery 11 of the BEV 10 at the departure time on the following weekday is also to be of the order of 90%.

Here, in a case in which the departure time is estimated from the schedule information on the user of the BEV 10, instead of the history information described above, the controller 21 of the information processing apparatus 20 may calculate the desired remaining battery charge of the battery 11 of the BEV 10 at the departure time, from the travel distance specified by the method described above.

Step S105: The controller 21 of the information processing apparatus 20 determines a charge time period of the battery 11, in a case in which it is determined that the battery 11 needs to be charged based on a comparison between the remaining battery charge estimated in step S102 and the desired remaining battery charge estimated in step S104.

Specifically, the controller 21 of the information processing apparatus 20 acquires an empty capacity of the battery 11 from the BEV 10 via the communication interface 22. The controller 21 then calculates a required charge amount by any method, based on the acquired empty capacity of the battery 11, the remaining battery charge (SOC) estimated in step S102, and the desired remaining battery charge (SOC) estimated in step S104. The controller 21 then determines the charge time period of the battery 11 based on the calculated required charge amount. In this example, the controller 21 determines that the battery 11 needs to be charged from 9:00 am to 4:00 pm on the following weekday to recover the remaining battery charge (SOC) of the BEV 10 by the order of 70% from the order of 20% at the arrival time to the order of 90% at the departure time. The controller 21 then determines the charge time period of the battery 11 to be from 9:00 am to 4:00 pm on the following weekday.

Here, the controller 21 of the information processing apparatus 20 may determine to discharge the battery 11 during the target time period when it is determined that the battery 11 does not need to be charged, based on a comparison between the remaining battery charge estimated in step S102 and the desired remaining battery charge estimated in step S104. Electrical energy discharge from the battery 11 may be consumed at residences or business facilities in the target area T as appropriate.

Step S106: The controller 21 of the information processing apparatus 20 determines whether the charge time period of the battery 11 is included in the target time period. In a case in which it is determined that the charge time period is included in the target time period, the process proceeds to step S107. On the other hand, in a case in which it is not determined that the charge time period is included in the target time period, the process ends.

In this example, the target time period is the following weekday (between 12:00 am and 11:59 pm) and the charge time period is between 9:00 am and 4:00 pm on the following weekday, so the process proceeds to step S107.

Step S107: The controller 21 of the information processing apparatus 20 adds the required charge amount for the BEV 10 to a demand for electrical energy in the target area T during the target time period.

Specifically, the controller 21 of the information processing apparatus 20 adds the required charge amount for the BEV 10 calculated in step S105 to the demand for electrical energy in the target area T on the following weekday (excluding, however, the required charge amount by the BEV 10), which is calculated or acquired in advance by any method and to be announced to an electrical energy retailer.

As described above, the controller 21 of the information processing apparatus 20 according to the present embodiment determines whether the vehicle 10 having the battery 11 for driving is to enter the target area T. Upon determining that the vehicle 10 is to enter the target area T, the controller 21 estimates the arrival time of the vehicle 10 at the target area T and the departure time of the vehicle 10 from the target area T. In a case in which the charge time period of the battery 11 in the target area T is included in the target time period, the controller 21 adds the required charge amount of the battery 11 to the demand for electrical energy during the target time period in the target area T.

According to such a configuration, even when a demand for charging the battery 11 for driving in the vehicle 10 tends to increase, the required charge amount of the battery 11 for driving in the vehicle 10 is added in advance to the demand for electrical energy in the target area T. Thus, technology for predicting demands for electrical energy can be improved.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

As a variation, an embodiment in which the configuration and operations of the information processing apparatus 20 are distributed to multiple computers capable of communicating with each other can be implemented. For example, an embodiment in which some or all of the components of the information processing apparatus 20 are provided in the vehicles 10 can also be implemented. For example, a car navigation device mounted in the vehicle 10 may include some or all of the components of the information processing apparatus 20.

As a variation, the controller 21 of the information processing apparatus 20 may determine a time period to discharge the battery 11 of the vehicle 10 and a time period to charge the battery 11 of the vehicle 10 in a time period from the arrival time to the departure time, based on the target time period, the charge time period, and the required charge amount in the embodiment described above. In addition, the controller 21 may determine to discharge the battery 11 of the vehicle 10 during a time period in which a demand for electrical energy in the target area T peaks. In this example, assuming that an estimated remaining battery charge at an arrival time (for example, 9:00 am) is 20%, an estimated remaining battery charge at a departure time (for example, 3:00 pm) is 70%, a target time period is between 2:00 pm and 3:00 pm on the following weekday, and the demand for electrical energy peaks between 2:00 pm and 2:30 pm on the following weekday. In this case, for example, the controller 21 may determine to charge the battery 11 of the vehicle 10 by any charge amount above a required charge amount (for example, up to SOC = 100%) during a time period from the arrival time to the start of the target time period (for example, from 9:00 am to 2:00 pm). The controller 21 may then determine to discharge the battery 11 of the vehicle 10 by the difference (for example, a charge amount of SOC = 30%) between the any charge amount above the required charge amount and the required charge amount, during the target time period (from 2:00 pm to 3:00 pm) including the time period in which the demand for electrical energy peaks. The difference may be determined by the user as appropriate to ensure that no additional purchases of electrical energy are made after the completion of the electrical energy contract in the target area T.

As a variation, the controller 21 of the information processing apparatus 20 may acquire the arrival time, departure time, and desired remaining battery charge from the user via an application running on a smartphone or tablet, instead of estimating the arrival time, departure time, and desired remaining battery charge as described above. The application is installed on the smartphone or tablet and provides a service to manage a driving status of the vehicle 10 and a charging status of the battery 11 based on input from the user of the vehicle 10. Upon connecting the vehicle 10 to a charging facility provided in the target area T, the controller 21 may acquire the remaining battery charge of the battery 11 at the arrival time from the vehicle 10 via the communication interface 22, instead of estimating the remaining battery charge of the battery 11 at the arrival time, as described above.

As a variation, in a case in which an event or the like is held in the target area T during a target time period, vehicles 10 that do not usually visit the target area T may visit the target area T in an irregular manner. In this case, the controller 21 of the information processing apparatus 20 may estimate an arrival time of the vehicles 10 at the target area T based on a start time of the event or the like, estimate a departure time of the vehicles 10 from the target area T based on an end time of the event or the like, or estimate the number of vehicles 10 that are to visit the target area T based on the number of visitors to the event or the like. Here, the controller 21 of the information processing apparatus 20 can acquire the start time, the end time, and the number of visitors to the event or the like via the communication interface 22 from any server or other source managed by an event operator or other entity. The remaining battery charge may be calculated as appropriate based on a distance between the target area T and location information indicating a home or the like of the user of the vehicle 10, acquired by the controller 21 by any method.

As a variation, the controller 21 of the information processing apparatus 20 may calculate a storage capacity of all batteries in the target area T, including batteries 11 for driving that individual vehicles 10 parked in the target area T have. Specifically, the controller 21 acquires, from stationary batteries via the communication interface 22, empty capacities and remaining battery charges of the stationary batteries in the target area T at a start time of a target time period (for example, 9:00 am on the following weekday). In the same manner as in the embodiment described above, the controller 21 acquires empty capacities and remaining battery charges of the batteries 11 of the individual vehicles 10 parked in the target area T at the start time of the target time period (for example, 9:00 am on the following weekday). Then, based on the acquired empty capacities and remaining battery charges of the stationary batteries and the empty capacities and remaining battery charges of the batteries 11 of the vehicles 10, the controller 21 sums available storage capacities of the stationary batteries in the target area T and available storage capacities of the batteries 11 of the vehicles 10 parked in the target area T to calculate an available storage capacity of all the batteries. Such an available storage capacity of all the batteries can be used to store surplus electrical energy from solar power generation in the target area T.

As a variation, an embodiment in which a general purpose computer functions as the information processing apparatus 20 according to the above embodiment can also be implemented. Specifically, a program in which processes for realizing the functions of the information processing apparatus 20 according to the above embodiment are written may be stored in a memory of a general purpose computer, and the program may be read and executed by a processor. Accordingly, the present disclosure can also be implemented as a program executable by a processor, or a non-transitory computer readable medium storing the program.

1. An information processing apparatus comprising a controller configured to:
determine whether a vehicle having a battery for driving is to enter a target area;
acquire or estimate an arrival time of the vehicle at the target area and a departure time of the vehicle from the target area, in a case in which it is determined that the vehicle is to enter the target area; and
add a required charge amount of the battery to a demand for electrical energy during a target time period in the target area, in a case in which a charge time period of the battery in the target area is included in the target time period.

2. The information processing apparatus according to claim 1, wherein the controller determines whether to charge or discharge the battery, based on a comparison between a remaining battery charge of the battery at the arrival time and a desired remaining battery charge of the battery at the departure time.

3. The information processing apparatus according to claim 1, wherein the controller determines, based on the target time period, the charge time period, and the required charge amount, a time period to discharge the battery and a time period to charge the battery in a time period from the arrival time to the departure time.

4. The information processing apparatus according to claim 3, wherein
the target time period includes a peak time period during which the demand for electrical energy peaks, and
the controller determines to discharge the battery during the peak time period.

5. A method performed by an information processing apparatus, the method comprising:
determining whether a vehicle having a battery for driving is to enter a target area;
acquiring or estimating an arrival time of the vehicle at the target area and a departure time of the vehicle from the target area, in a case in which it is determined that the vehicle is to enter the target area; and
adding a required charge amount of the battery to a demand for electrical energy during a target time period in the target area, in a case in which a charge time period of the battery in the target area is included in the target time period.

6. A non-transitory computer readable medium storing a program configured to cause a computer to execute operations, the operations comprising:
determining whether a vehicle having a battery for driving is to enter a target area;
acquiring or estimating an arrival time of the vehicle at the target area and a departure time of the vehicle from the target area, in a case in which it is determined that the vehicle is to enter the target area; and
adding a required charge amount of the battery to a demand for electrical energy during a target time period in the target area, in a case in which a charge time period of the battery in the target area is included in the target time period.
